(19) United States
(12) Patent Application Publication
(10) Pub. No.: US 2025/0180388 A1
(43) Pub. Date: Jun. 5, 2025

(54) LIQUID DOSING DEVICE

(71) Applicant: Oleg Volodymyrovych MOLCHANOV, Svitlovodsk (UA)

(72) Inventor: Oleg Volodymyrovych MOLCHANOV, Svitlovodsk (UA)

(21) Appl. No.: 18/715,669

(22) PCT Filed: Nov. 28, 2022
(86) PCT No.: PCT/UA2022/000070

§ 371 Date: Dec. 13, 2024

(30) Foreign Application Priority Data
Dec. 6, 2021 (UA) U 2021 06933

(51) Int. Cl. G01F 11/02; A61J 1/18; A61J 1/20

(52) U.S. Cl. CPC G01F 11/028; A61J 1/18; A61J 1/20; A61J 2200/76

(57) ABSTRACT

A liquid dosing device comprises, arranged in axial alignment with the neck (1) of a container and concentrically relative to one another, the following cylindrical elements: a cylindrical housing (3) with a cap (2), a measuring cylinder (4), and a calibrated plunger (10), wherein the measuring cylinder (4) and the calibrated plunger are axially moveable with the aid of a lever (5) provided on the side surface of the measuring cylinder (4), and the measuring cylinder (4) is provided with openings which alternately align with an inlet opening and an outlet opening in the cylindrical housing (3) when the measuring cylinder (4) is moved. The measuring cylinder (4) has a continuation of its cylindrical wall, forming a drainage element (4.2) above discharge openings (9) in its cylindrical surface, as well as a sealing element in the form of a cylindrical wall (4.3) at the point of contact with the calibrated plunger (10). The cap (2) of the cylindrical housing (3) has a locking element that provides tight contact with the neck (1) of the container.

The technical solution relates to devices for dispensing liquids and can be used to measure a certain volume of liquid, when pouring it out of containers, in particular, but not exclusively from universal consumer containers. The claimed device can be used in the food, pharmaceutical, chemical industry, in production together with containers for liquid food products that require metered use, as well as a separate product for use in the home.

A bottle filler is known [GB 1434892, publ. 05.05.1976], which has a cylindrical hollow body which is hermetically connected to the neck of the bottle, a control dosing chamber placed coaxially inside the cylindrical hollow body and forms with the latter an annular spillage channel which is connected on the outer side to an annular outlet opening. A small air intake tube extends from the dispensing chamber to the interior of the bottle and forms the inner wall of the annular opening, which allows liquid to flow from the bottle into the dispensing chamber and in the annular space between the housing and the air intake tube there are means for preventing air from entering the interior of the bottle through the annular spill channel.

A measuring device for inserting into the neck of a liquid container is known [U.S. Pat. No. 4,582,230, publ. 11.10.1983], comprising an elongated cylinder having a cylindrical outlet opening which extends beyond the neck of said liquid container and one or more openings at the other end which are connected to the interior of the liquid container, a dosing chamber in said elongated cylinder to said outlet opening, a ball valve chamber in said elongated cylinder and a ball valve between the interior of the container and the dosing chamber. The ball valve, comprising a ball and a seat, is located near the inlet opening of the dosing chamber on the container side. The valve ball is connected by a piston rod to a piston mounted for movement in the cylindrical outlet opening of the dosing chamber.

The disadvantages of the given analogues are limited functional possibilities concerning the changeable regulation of the volume of liquid poured out of the container (the device is designed to pour out a constant volume determined by the volume of the dosing chamber). In addition, the product is mounted directly to the neck of the bottle and is not intended to be used as a separate, reusable product with different containers.

A known device for storing and accurately dosing liquids [RU2123466, publ. 20.12.1998.], which includes a bottle for storing liquid located between the bottom of the bottle and its neck, a cap, which differs in that the cap is mounted on the neck of the bottle and connected to a hollow cylinder which is arranged along the central axis of the bottle to it, the bottom having an open upper end and a lower end with a central opening and comprises a dispensing device which performs a reciprocating movement inside the cylinder which comprises a sleeve and a plunger, and the sleeve accommodates an upper part having a larger diameter than the lower part. The dispensing device has a lower end having a centre opening that is aligned with the centre opening of the cylinder, wherein the plunger includes a piston, a graduated piston rod and head, and a centre opening.

The disadvantages of the known device are imperfect design, which does not provide reliable sealing, convenience and continuity of operation.

The closest analogue for technical essence to the utility model, which is claimed, is a device for dosing liquids [UA 113714, MPK G01F 11/00, published. 27.02.2017, bibl. no. 4, 2017], which has a cylindrical body with inlet and outlet openings coaxially located with the lid of the neck of a consumer container, a measuring cylinder concentrically mounted therein, installed with the possibility of axial movement at the moment of liquid measurement. In this case, the cylindrical body is mounted inside the lid of the consumer container, partially located inside the consumer container with the possibility of axial movement from the neck of the lid of the consumer container and back, the measuring cylinder has openings that alternately align with the inlet and outlet openings of the cylindrical body when moving the measuring cylinder with the help of an external mechanism mounted on the side surface of the measuring cylinder with the possibility of interaction between the mechanism and the measuring cylinder, and in the end surface of the measuring cylinder with the measuring cylinder.

The disadvantages of the closest analogue is that the closest analogue does not provide prevention of overflow of liquid on the graduated piston during its dosing, which causes its spilling and reduces the accuracy of measurement. It does not provide sufficient tightness of the device when it is installed on containers with liquid instead of the lid. There is no restriction of movement of parts of the device, which would increase the convenience of its mounting and dismounting on the neck of the tank.

The technical solution is based on the task of improving the design of the liquid dispenser to ensure high tightness of the device, to prevent overflow of liquids between structural elements outside the provided by-pass channels and, as a consequence, to increase the convenience of operation and reliability of installation of the device.

The set task is achieved by the fact that the liquid dispenser contains cylindrical elements located coaxially to the container neck and concentrically relative to each other: cylindrical body with a lid, measuring cylinder and graduated piston, in this case the measuring cylinder and graduated body are made with the possibility of axial movement by means of a lever placed on the side surface of the measuring cylinder, and the measuring cylinder has openings, which alternately align with the inlet and outlet openings of the cylindrical body at the transfer of the liquid dispenser. The measuring cylinder has a continuation of the cylindrical wall, forming a drain over the discharge openings of its cylindrical surface, and also a sealing element in the form of the cylindrical wall at the point of contact with the graduated piston. In this case, the lid of the cylindrical body has a fixing element, which provides a tight contact with the neck of the container.

According to a preferred embodiment of the utility model, an annular sealing gasket is installed under the cover of the cylindrical body.

According to a preferred embodiment of the utility model, the fixing element of the lid of the cylindrical body is made in the form of latches or a thread coil, wherein in the upper part of the lid there is a recess with latches, in which the protrusion of the cylindrical body is fixed, and in the lower part there is an inner cylindrical protrusion, on which there is at least one annular protrusion, which fits tightly to the cylindrical body.

According to a preferred embodiment of the utility model, the inlet opening of the cylindrical body is closed by a drop-down plug.

According to a preferred embodiment of the utility model, the opening of the cylindrical body, in which the lever of the measuring cylinder moves, is made connected with the upper end part of the cylindrical body, and the free exit of the lever from the cylindrical body is prevented by at least one latch, which are installed on the corresponding portions of the wall of the upper end part of the cylindrical body, have a height greater than the other part of the cylindrical body.

According to a preferred embodiment of the utility model, in the lower part of the cylindrical body there is at least one retainer (latch or circular protrusion) which, when the cylindrical body is moved to its upper operating position, contacts the gasket or the lower edge of the cover of the cylindrical body and prevents its escape from the cover.

According to a preferred embodiment of the utility model, the cylindrical wall located near the opening in the measuring cylinder through which the graduated piston enters and leaves the measuring cylinder is provided with at least one annular protrusion (recess) which is in contact with the circular recesses (protrusions) on the graduated piston corresponding to the scale.

According to a preferred embodiment of the utility model, circular recesses (protrusions) are installed on the graduated piston through each scale graduation, which move stepwise between the circular protrusions (recesses) in the cylindrical wall of the measuring cylinder and fix their position, and at least one latch or circular protrusion is installed at the bottom of the graduated piston, which prevent the graduated piston from completely leaving the measuring cylinder.

According to a preferred embodiment of the utility model, on the outer surface of the measuring cylinder on the lever side there is a longitudinal recess which starts under the lever and ends at the edge of the lower opening of the measuring cylinder, which, when the measuring cylinder is moved upwards to transfer the measured liquid, connects with the lower part of the longitudinal opening of the cylindrical body in which the lever is moving.

According to a preferred embodiment of the utility model, at least one annular protrusion is arranged on the outer surface of the measuring cylinder.

According to a preferred embodiment of the utility model, an additional outer cover is provided on the top of the device, which is mounted on the outer part of the dispenser lid and prevents moisture and dust from getting on the dispenser parts, and blocks the external environment from accessing the liquid that is stored in the container between its use.

The applicant's analysis of the prior art, which includes a search of patent and scientific and technical sources of information, identification of sources that contain information about analogues of the claimed invention, allowed to establish that the applicant has not identified an analogue that is characterized by features identical to the essential features of the claimed technical solution.

The essence of the utility model is explained by the drawings.

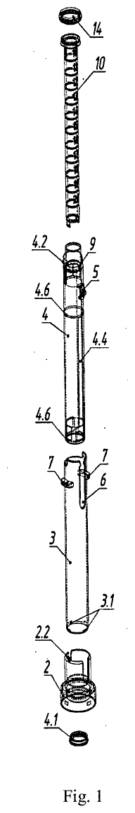

FIG. 1-showing an exploded view of the liquid dispenser.

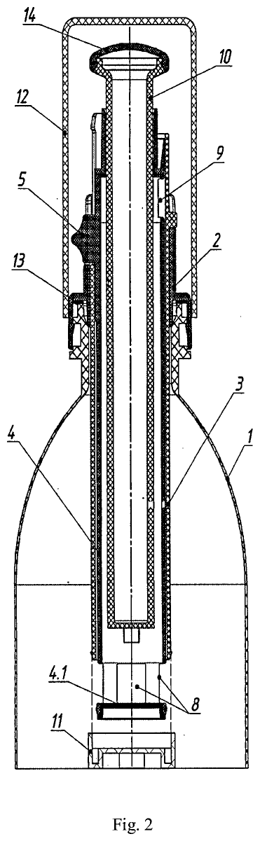

FIG. 2-shows a general view of the installation of the liquid dispenser to the neck of the consumer container.

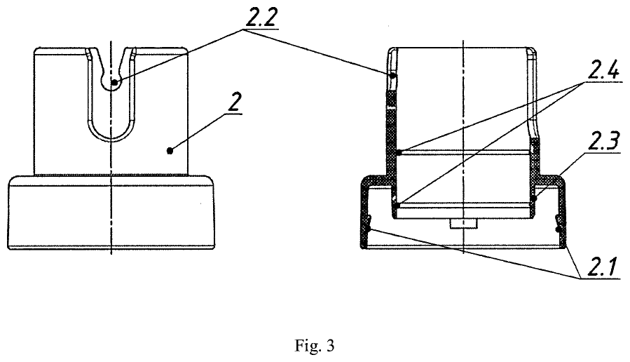

FIG. 3-shows the cover of the cylindrical body in section.

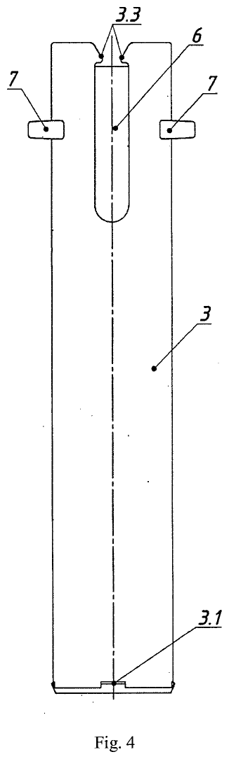

FIG. 4-shows a cylindrical body (front view).

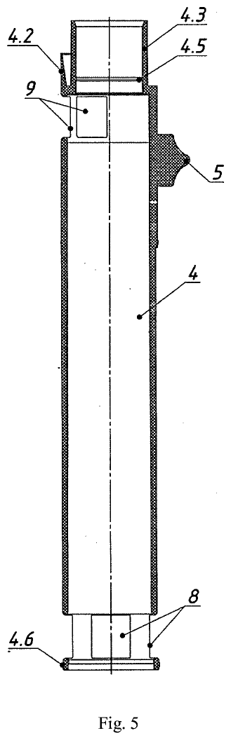

FIG. 5-shows the measuring cylinder (in section).

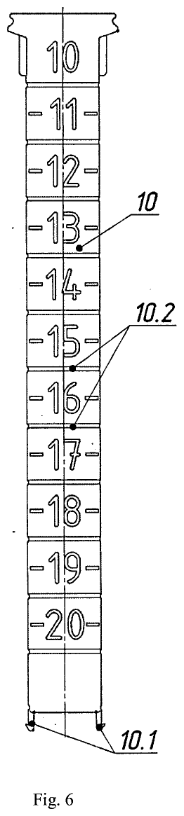

FIG. 6-showing a graduated piston.

### THE DRAWINGS INDICATE

1-neck of consumer container;
2-cylindrical housing cover;
2.1-protrusions on the inside of the lid;
2.2-recess in the upper part of the lid with latches;
2.3-internal cylindrical protrusion in the lower inner part of the lid;
2.4-annular protrusions on the inner surface of the inner cylindrical protrusion;
3-cylindrical body;
3.1-latches at the bottom of the cylindrical housing;
3.2-protrusion in the cylindrical body;
3.3-cylindrical housing latches;
3.4-raised walls of the upper end part of the cylindrical body;
4-measuring cylinder;
4.1-measuring cylinder lid;
4.2-wall of the measuring cylinder above its upper openings;
4.3-cylindrical wall of the measuring cylinder;
4.4-longitudinal recess on the outer surface of the measuring cylinder;
4.5-annular protrusion on the inner surface of the cylindrical wall of the measuring cylinder;
4.6-upper and lower ring protrusions on the outer surface of the measuring cylinder;
5-lever;
6-cylindrical housing opening;
7-handles;
8-bottom openings of the measuring cylinder;
9-top openings of the measuring cylinder;
10-graduated piston;
10.1-latches at the bottom of the graduated piston;
10.2-step annular recesses in graduated piston;
11-falling out plug of the cylindrical body;
12-outer cover;
13-gasket;
14-graduated piston cap.

The liquid dispenser is mounted on the consumer container 1 with the help of the dispenser cap 2, engaging to the protrusions of the consumer container with protrusions 2.1. Tightness of the connection between the consumer container 1 and the dispenser lid 2 is ensured by the gasket 13, which is installed under the lower surface of the lid, as well as the inner cylindrical protrusion 2.3 and the inner surface of the neck of the consumer container. In the neck of the lid 2 is located with the possibility of axial movement of the cylindrical body 3, tightness of connection of which with the lid 2 is also provided by the gasket 13 and/or ring protrusions 2.4 on the inner cylindrical protrusion of the lid, which tightly fit the outer walls of the cylindrical body, preventing leakage of liquid between the lid and the cylindrical body. In the upper part of the cylindrical body 3 there is a protrusion 3.2, which is connected to the lid 2 in the recess of the lid 2 by latches 2.2 in its lower operating position. In the lower part of the cylindrical body 3 there are latches 3.1, which in the upper position of the cylindrical body 3 prevent it from leaving the lid 2 by engaging the inner cylindrical protrusion 2.3. A measuring cylinder 4 is mounted inside the cylindrical body 3. The cylindrical body 3 has openings at both ends (inlet and outlet openings) through which the liquid alternately enters the measuring cylinder and exits it to the outside.

The cylindrical body 3, which is connected by means of a lid 2 to the neck of the consumer container 1, inside houses a measuring cylinder 4, which in the lower part is connected to the inside of the consumer container and has openings 8 through which the liquid is drawn from the container, In the upper part of the measuring cylinder 4 there are openings 9, which in the operating position are connected to the outside environment, and through which the measured liquid is poured out of the device. At the bottom of the measuring cylinder 4 a cover 4.1 is provided, which is structurally necessary for the manufacture of the measuring cylinder 4. Above the upper openings 9 of the measuring cylinder 4, as a continuation of the cylinder walls there is a wall 4.2, which when pouring the measured liquid from the measuring cylinder does not allow the liquid to flow to the graduated piston 10 and cuts off the liquid residue on the measuring cylinder 4 when returning it to the lower working position. On the outer surface of the measuring cylinder 4 there is a longitudinal recess 4.4, which in the upper working position of the measuring cylinder connects with the opening of the cylindrical body 6, and opens the air access to the lower part of the measuring cylinder, thus ensuring free flow of the measured liquid from the measuring cylinder. On top of the opening (not indicated in the drawing) located in the end part of the measuring cylinder 4, which goes outside, there is a cylindrical wall 4.3, the inner surface of which is adjacent to the outer surface of the calibrated piston 10 with the possibility of its movement inside the cylindrical wall, and has the possibility of axial movement in and out of the measuring cylinder, changing its volume. On the inner surface of the cylindrical wall 4.3 there is an annular protrusion 4.5, which alternately engages with the annular recesses 10.2 in the graduated piston 10 during its step-by-step movement inside the measuring cylinder and outwardly, ensuring that no liquid flows between the measuring cylinder 4 and the graduated piston 10. From above, the graduated piston 10 is closed with a cap 14. On the outer surface of the measuring cylinder 4, there are annular protrusions 4.6 at the top and bottom, which are adjacent to the inner walls of the cylindrical body 3 with the possibility of moving along them and preventing the flow of liquid between the walls of the cylindrical body 3 and the walls of the measuring cylinder 4. At the bottom of the graduated piston 10 are latches 10.1 which prevent the graduated piston 10 from fully exiting the measuring cylinder 4. The measuring cylinder 4 moves by axial movement—in the cylindrical body by means of a lever 5, the longitudinal movement of which is limited by the end of the opening 6 in the cylindrical body 3, on the one side, and by the latches 3.3 on the other side. In this case, when lever 5 together with measuring cylinder 4 moves to the middle position in opening 6 (halfway), both openings (inlet and outlet) of the cylindrical body are blocked by the end parts of the measuring cylinder, which prevents the unmeasured liquid from pouring out of the consumer container. When the lever 5 is fully moved to the latch 3.3 and enters the working position, the measured liquid is poured into the prepared container. At the same time, the longitudinal recess 4 A in the measuring cylinder is connected through the opening 6 in the cylindrical body 3 and air flows through it into the lower part of the measuring cylinder, ensuring quick pouring out of the measured liquid. The cylindrical body 3 has handles 7 at the top, by means of which the cylindrical body 3 of the device is removed by the protrusion 3.2 from the latches 2.2 of the lid of the dispenser 2 and moved at the lid 2 from the neck 1 of the consumer container and back, when it is necessary to fully utilize the liquid from the consumer container 1.

The technical solution is realized as follows.

Install the device on the neck of the consumer container 1 with the help of the lid 2, through the gasket 13, fixing the connection of the consumer container 1 with the lid 2 by means of protrusions 2.1. Remove the outer cover 12 from the device. When small and precise volumes of liquid are to be measured, the graduated piston 10 is moved to the position that corresponds to the required volume of the liquid to be measured. When the lever 5 of the measuring cylinder 4 is pressed down with force, then under the pressure of the end part of the measuring cylinder 4 the falling out plug 11 is removed from the cylindrical body 3 and falls to the bottom of the consumer container, opening the access of liquid to the device. At the same time, the measuring cylinder 4 of the device moves to the initial position, when the lever 5 and cylinder 4 are lowered down, and the openings 8 are open for access of liquid from the consumer container 1 to them. Then tilt the consumer container with liquid and fill the measuring cylinder 4. Move lever 5 as far as it will go. At the same time, the measuring cylinder 4 is moved, the openings 8 are closed for liquid access, and then the openings 9 are opened, through which the measured liquid is poured out. The lever 5 is returned to its initial position and the measuring cylinder 4 is filled with a new portion of liquid. When most of the liquid from the container has been measured and poured out, and the liquid in the tilted container falls below the openings 8 through which it is drawn from the container, the cylindrical body 3 is moved outwards from the consumer container 1 by means of handles 7, so that it is possible to measure all the liquid that is in the consumer container. Thus, the liquid dispenser makes it possible to measure volumes of liquid set within certain limits allowed by the constructional design of the device.

The device in this form hermetically seals the consumer container and can be mounted instead of a lid on the consumer container with the liquid to be measured. The liquid to be measured, which is poured out of the device, does not spill or overflow. The liquid dispenser is easy to assemble/disassemble and clean and is designed to be reusable, thus reducing environmental impact. At the same time, it is easy to use and ergonomically shaped. The device is compact, connects with a lid to the unified necks of consumer containers, and the lid of the cylindrical body for different necks of consumer containers can be replaced according to the design of the neck of the consumer container.

The liquid dispenser can be made of polymeric materials (including those obtained by recycling) using known technologies. In the application materials the technical solution is fully described, and the prototypes have been tested, i.e. it meets the criterion of patentability of a utility model “industrial suitability”.

1. Liquid dispenser, which contains concentrically placed relative to each other cylindrical elements: a cylindrical body with a lid, a measuring cylinder and a graduated piston, with the measuring cylinder and the graduated piston are made with the possibility of axial movement with the help of a lever installed on the side surface of the measuring cylinder, and in the measuring cylinder holes are made, which alternately coincide with the inlet and outlet holes of the cylindrical body when moving the measuring cylinder, which differs in that the measuring cylinder has a continuation of the cylindrical wall, forming a drain over the discharge holes of its cylindrical surface, and a sealing element in the form of the cylindrical wall at the point of contact with the graduated piston, wherein the lid of the cylindrical body has a fixing element that ensures tight contact with the neck of the container.

2. The liquid dispenser according to cl. 1, which differs in that a ring sealing gasket is installed under the lid of the cylindrical body.

3. The liquid dispenser according to cl. 1, which differs in that it has a fixing element of the lid of the cylindrical body, made in the form of latches or a turn of thread, where in the upper part of the lid there is a recess with latches, in which the protrusion of the cylindrical body is fixed, and in the lower part there is an inner cylindrical protrusion, wherein there is at least one annular protrusion, which fits tightly to the cylindrical body.

4. The liquid dispenser according to cl. 1 which differs in that the inlet opening of the cylindrical body is closed by a drop-out plug.

5. The liquid dispenser according to cl. 1, which differs in that the bore of the cylindrical body in which the lever of the measuring cylinder is arranged is connected to the upper end portion of the cylindrical body, and the free exit of the lever from the cylindrical body is preempted by means of latches mounted on corresponding wall portions of the upper end portion of the cylindrical body, and has a height which is greater than the height of another wall portion of the upper end portion of the cylindrical body.

6. The liquid dispenser according to cl. 1, which differs in that in the lower part of the cylindrical body there is at least one retainer (latch or annular protrusion) which, when the cylindrical body is moved to its upper working position, contacts the gasket or the lower edge of the lid of the cylindrical body and prevents it from coming out of the lid.

7. The liquid dispenser according to cl. 1, which differs in that the cylindrical wall adjacent to the bore in the measuring cylinder through which the graduated piston enters and leaves the cylinder is provided with at least one annular protrusion (recess) which comes into contact with the annular recesses (protrusions) on the graduated piston.

8. Liquid dispenser according to cl. 1, which differs in that on the graduated piston through each scale graduation are made annular recesses (protrusions), which step coincide with the annular recess (protrusion) in the cylindrical wall of the measuring cylinder and fix its position, and at least one latch or annular protrusion is installed at the bottom of the graduated piston, which prevents the graduated piston from completely leaving the measuring cylinder.

9. The liquid dispenser according to cl. 1, which differs in that on the outer surface of the measuring cylinder on the lever side there is a longitudinal recess starting under the lever and ending at the edge of the lower opening of the measuring cylinder, which, when moving the measuring cylinder upwards to pour the measured liquid, connects with the lower part of the longitudinal opening of the cylindrical body in which the lever moves.

10. The liquid dispenser according to cl. 1, which differs in that the outer surface of the measuring cylinder is provided with at least one annular protrusion.

11. The liquid dispenser according to cl. 1, which differs in that an additional outer cover is made on the top of the device, which contacts the outer part of the dispenser cover and prevents moisture and dust from getting on the dispenser parts, and blocks access of the outside environment to the liquid, which is stored, in the container between its use.
